(19) United States
(12) Patent Application Publication
(10) Pub. No.: US 2024/0205593 A1
(43) Pub. Date: Jun. 20, 2024

(54) ACTUATOR WITH DISTRIBUTED RESONANCES

(71) Applicant: Sound Solutions International (Zhenjiang) Co. Ltd., Zhenjiang City, Jiangsu Province (CN)

(72) Inventors: Friedrich Reining, Vienna (AT); Manuel Mefleh, Vienna (AT)

(21) Appl. No.: 18/539,188

(22) Filed: Dec. 13, 2023

(30) Foreign Application Priority Data
Dec. 14, 2022 (AT) A50958/2022

(51) Int. Cl. H04R 1/28; H04R 1/02; H04R 7/04; H04R 9/02; H04R 9/04; H04R 9/06

(52) U.S. Cl. CPC H04R 1/2873; H04R 1/028; H04R 7/04; H04R 9/025; H04R 9/045; H04R 9/046; H04R 9/06; H04R 2499/15

(57) ABSTRACT

An electrodynamic actuator (1a . . . 1f) is disclosed, which comprises at least one voice coil (3a, 3b, 4a . . . 4c, 14a, 14b), a magnet system (9a, 9b) and a plurality of arms (7a . . . 7h) movably coupling the at least one voice coil (3a, 3b, 4a . . . 4c, 14a, 14b) and the magnet system (9a, 9b) or a movable part (10) of the magnet system (9a, 9b). A first magnet subsystem (11a) and a first part (12a) of the arms (7a . . . 7h) form a first oscillating system (13a) with a first resonance frequency fres₁, and a second magnet subsystem (11b) and a second part (12b) of the arms (7a . . . 7h) form a second oscillating system (13b) with a second resonance frequency fres₂, which is different from the first resonance frequency fres₁. Additionally, an electrodynamic transducer (16a, 16b), an output device and a speaker (19) with such an electrodynamic actuator (1a . . . 1f) is disclosed.

### PRIORITY

This patent application claims priority from Austrian patent application No. A50958/2022, filed Dec. 14, 2022, entitled, “Actuator with Distributed Resonances,” the disclosure of which is incorporated herein, in its entirety, by reference.

### BACKGROUND

### a. Technical Field

The invention relates to an electrodynamic actuator, which in particular is designed to be connected to a plate like structure or membrane and which comprises at least one voice coil having an electrical conductor in the shape of loops running around a coil axis in a loop section and a magnet system being designed to generate a magnetic field transverse to the electrical conductor in the loop section. In addition, the electrodynamic actuator comprises a plurality of arms, which a) mechanically couple the at least one voice coil and the magnet system and which allow a relative movement between the at least one voice coil and said magnet system in an excursion direction parallel to the coil axis or b) which mechanically couple the at least one voice coil and a movable part of the magnet system and which allow a relative movement between the at least one voice coil and said movable part of the magnet system in an excursion direction parallel to the coil axis. Moreover, the invention relates to an electrodynamic transducer, comprising a plate like structure and an electrodynamic actuator of the above kind, which is connected to the plate like structure. The invention also relates to an output device, wherein the above plate like structure is embodied as a display and wherein the electrodynamic actuator is connected to the backside of the display. Finally, the invention relates to a speaker with an electrodynamic actuator of the aforementioned kind and a membrane connected thereto.

### b. Background Art

An electrodynamic actuator, an electrodynamic transducer, an output device and a speaker of the aforementioned kinds are generally known in prior art. For example, US 2005/0031152 A1 discloses an electrodynamic actuator, which is similar to the electrodynamic actuator of the aforementioned kind.

Generally, design of the above devices can get challenging if a favorable frequency response of the same shall be obtained. Often, such devices have a (single) pronounced resonance rise by nature what foils a desired flat frequency response. Hence, a designer of such devices may be forced to reduce such a pronounced resonance rise based on application requirements, which by nature limits his options for the rest of the device design.

### SUMMARY OF THE INVENTION

Accordingly, it is an object of the invention to overcome the drawbacks of the prior art and to provide an improved electrodynamic actuator, an improved electrodynamic transducer, an improved output device and an improved speaker. In particular, the effect of a pronounced resonance rise in the frequency response of these devices shall be reduced and design freedom shall be improved.

The problem of the invention is solved by an electrodynamic actuator as defined in the opening paragraph, wherein in case a) the magnet system and in case b) the movable part of the magnet system comprises a plurality of magnet subsystems, which are movable to each other in the excursion direction, a first magnet subsystem of the magnet subsystems and a first part of the arms, which mechanically couple the at least one voice coil and the first magnet subsystem, form a first oscillating system with a first resonance frequency fres₁ and a second magnet subsystem of the magnet subsystems and a second part of the arms, which mechanically couple the at least one voice coil and the second magnet subsystem, form a second oscillating system with a second resonance frequency fres₂, which is different from the first resonance frequency fres₁.

The problem of the invention is also solved by an electrodynamic transducer, which comprises a plate like structure and an electrodynamic actuator of the above kind, which is connected to the plate like structure (in particular to the backside of the plate like structure opposite to a sound emanating surface of the plate like structure, wherein said backside is oriented perpendicularly to the coil axis).

In this context, it is of advantage if the at least one voice coil or the (movable part of the) magnet system of the electrodynamic actuator comprises a flat mounting surface, which is intended to be connected to the plate like structure.

Moreover, the problem of the invention is solved by an output device, wherein the above plate like structure is embodied as a display and wherein the electrodynamic actuator is connected to the backside of the display.

Finally, the problem of the invention is solved by a speaker with an electrodynamic actuator of the aforementioned kind and a membrane connected thereto. In particular, the membrane is fixed to the at least one coil, to the magnet system in case a) or to the movable part of the magnet system in case b).

By use of the proposed measures, distributed resonance rises in the frequency response can be obtained giving the designer of the electrodynamic transducer more design freedom. In particular, a single sharp resonance can be avoided. This is particularly true if a ratio between the second resonance frequency fres₂ and the first resonance frequency fres₁ is in a range of 0.5≤fres₂/fres₁<1.0 or 1.0<fres₂/fres₁≤2.0.

In the given context, a “part of the arms” can either mean a subset of the arms (here the total number of arms is divided into more subsets) or a section or sections of the arms (here the arms themselves are divided into more sections).

Generally, the “arms” besides the lateral fixation of the magnet system in case a) or the movable part of the magnet system in case b) may have different additional functions. On the one hand, they may mainly act as springs and together with the mass of the magnet system in case a) or the movable part of the magnet system in case b) form an oscillating system. On the other hand, they may (alternatively or additionally) act as dampers for the oscillating system. Accordingly, the arms may also be seen and denoted as “spring arms,” “damping arms” or “combined spring and damping arms”. Generally, the different functions can be influenced by giving the arms a distinct shape and/or by making them of a particular material. An arm is not necessarily a straight bar but can be bent in its relaxed state. An arm may also be part of a superordinate bar arrangement, which for example interconnects a plurality of arms. Arms can be arranged on the top and/or on the bottom side of magnet system in case a) or of the movable part of the magnet system in case b). The arms are not necessarily directly connected to the voice coil and to the magnet system or to the movable part of the magnet system but can be connected thereto indirectly as well, e.g. by use of a housing or frame.

Generally an “electrodynamic actuator” transforms electrical power into movement and force. An electrodynamic actuator together with a membrane forms a “speaker”. An electrodynamic actuator together with a plate forms an “electrodynamic (acoustic) transducer”. A special embodiment of a plate is a display. In this case, an electrodynamic actuator together with a display forms an “output device” (for both audio and video data). Generally, a speaker, an electrodynamic transducer and an output device transform electrical power into sound. Generally, the above devices may also be intended for generation of vibration for haptic feedback.

It should be noted that sound can also emanate from the backside of the plate like structure and the membrane. However, this backside usually faces an interior space of a device (e.g. a mobile phone), which the speaker or output device is built into. Hence, the plate like structure or membrane may be considered to have the main sound emanating surface and a secondary sound emanating surface (i.e. said backside). Sound waves emanated by the main sound emanating surface directly reach the user's ear, whereas sound waves emanated by the secondary sound emanating surface do not directly reach the user's ear, but only indirectly via reflection or excitation of other surfaces of a housing the device, which the speaker or output device is built into.

A “movable part of the magnet system” in the context of the disclosure means a part of the magnet system which can move relatively to the at least one voice coil. Generally, a magnet system may have a fixed part, which is fixedly mounted to the voice coil or fixedly mounted in relation to the voice coil, and a movable part. It is also possible, that the whole magnet system is movable in relation to the at least one voice coil. In this case the movable part of the magnet system is the magnet system itself, and there is no fixed part.

The electrodynamic acoustic transducer may comprise a frame and/or a housing.

A “frame” can hold together the membrane, the voice coil and the magnet system. The frame can directly be connected to the membrane and the magnet system (e.g. by means of an adhesive), whereas the voice coil is only connected to the membrane. Hence, the frame can be fixedly arranged in relation to the magnet system. However, it may also be the other way around. The frame together with the membrane, the voice coil and the magnet system can form a sub system, which is the result of an intermediate step in a production process.

A “housing” can be mounted to the frame and/or to the membrane and encompasses the back volume of a transducer, i.e. an air or gas compartment behind the membrane. Hence, the housing can fixedly be arranged in relation to the magnet system. In common designs, the housing can be hermetically sealed respectively airtight. However, it may also comprise small openings or bass tubes as the case may be. Inter alia by variation of the back volume respectively by provision of openings in the housing, the acoustic performance of the transducer can be influenced.

It is noted that deviations from given numbers defined in the patent claims, which are unavoidable in reality due to technical tolerances, generally shall be covered by those patent claims anyway. In particular, this means that numbers defined in the patent claims are considered to include a range of +/−10% in view of the base value.

Further advantageous embodiments are disclosed in the claims and in the description as well as in the figures.

In a beneficial embodiment, the electrodynamic actuator can comprise—a plurality of voice coils, each having an electrical conductor in the shape of loops running around a common coil axis in loop sections or around separate coil axes being oriented parallel to each other, wherein the magnet system is designed to generate a magnetic field transverse to the electrical conductors in the loop sections and wherein the arms allow a relative movement between the voice coils and in case a) the magnet system or in case b) the movable part of the magnet system in an excursion direction parallel to the common coil axis or parallel to the separate coil axes.

By these measures, the effective length of the electric conductors arranged in the magnetic field generated by the magnet system can be increased in view of a solution with just one voice coil. Accordingly, the force, which is implied on the arrangement when currents flow through the electric conductors of the voice coils, is higher compared to a solution with just one voice coil. It is noted that the voice coils may electrically be switched in parallel, in series or may be driven individually.

In an advantageous embodiment of the electrodynamic actuator, the magnet system in case b) comprises permanent magnets and a first iron body, wherein the movable part of the magnet system is formed by or comprises the permanent magnets, wherein an arrangement is formed by the first iron body and the at least one voice coil, wherein the at least one voice coil is fixed to or embedded in the first iron body and wherein the arms allow a relative movement between said arrangement and the permanent magnets in an excursion direction parallel to the coil axis. In this way, the mass of the movable part of the magnet system can be reduced compared to common designs of electrodynamic actuators where the iron body is fixedly connected to permanent magnets.

It is very advantageous if the permanent magnets are each magnetized in a magnetizing direction transverse to the coil axis (in particular perpendicular to the coil axis and/or in particular in contrary or opposite directions). By use of these measures, the electrodynamic actuator can be made comparably flat in view of the strength of the magnetic field generated by the permanent magnets. Accordingly, such an electrodynamic actuator particularly can be used in flat consumer devices, for example in mobile phones, computer tablets, personal digital assistants, mobile computers, etc.

In another advantageous embodiment of the electrodynamic actuator, the voice coils are nested when viewed in a direction parallel to the excursion direction and at least overlap when viewed in a direction perpendicular to the excursion direction. In other words, a second voice coil is arranged within a first voice coil. By these measures, the effective length of the electric conductors arranged in the magnetic field can particularly be increased in case of permanent magnets, which are magnetized in contrary magnetizing directions transverse to the coil axis. For example, two nested voice coils can be provided, however, it is also possible to arrange a second voice coil within a first voice coil and to arrange a third voice coil within the second voice coil, and so on.

Advantageously, the electrodynamic actuator can have an outer voice coil of the nested voice coils and a plurality of inner voice coils of the nested voice coils, wherein the inner voice coils are arranged next to each other with a space in-between. This embodiment provides the possibility of mechanically connecting parts of the magnet system or of the movable part of the magnet system. Accordingly, the synchronously moving mass can be increased what provides the possibility of using harder or stiffer arms when the resonance frequency of the oscillating system is held constant. Advantageously, harder or stiffer arms are more durable when it comes to mechanical stress tests, in particular to drop tests.

In one beneficial embodiment, the electrodynamic actuator can comprise a second iron body, which connects at least two parts of the magnet system in case a) or at least two parts of the movable part of the magnet system in case b) or a non-iron body, which connects at least two parts of the magnet system in case a) or at least two parts of the movable part of the magnet system in case b). By use these measures, generally parts of the magnet system in case a) or of the movable part of the magnet system in case b) can be forced to synchronously move. When using a second iron body, a magnetic flux within the magnet system may be guided, whereas the parts in question can mechanically be interconnected without influencing the magnetic field by use of a non-iron body. Using a non-iron body, which can be made from plastics, can be useful if the aforementioned permanent magnets are magnetized in contrary directions transverse to the coil axis. The non-iron body may also have distinct elasticity and damping characteristics to allow a predetermined movement between the connected parts in question.

In one further embodiment of the electrodynamic actuator, the voice coils can have a circular, rectangular or oval contour when viewed in a direction perpendicular to the excursion direction (in particular a rectangular contour with rounded corners). In this way, the voice coils can be manufactured by proven technical means. Moreover, rectangular or oval voice coils fit to the form factor of common mobile devices very well.

Advantageously, the outer voice coil of the nested voice coils can have a circular contour or a rectangular contour with rounded corners and the inner voice coil of the nested voice coils can have an oval contour or also a rectangular contour with rounded corners when viewed in a direction perpendicular to the excursion direction (in particular, the oval comprises parallel straight sections on the longer side). By use of these measures, the magnetic resistance of the magnetic circuit is comparably low.

It is very advantageous if the voice coils are fully enclosed by the first iron body at the shorter sides of their rectangular or oval contour and run side by side to the first iron body at the longer sides of their rectangular or oval contour. By use of these measures, a favorable circular magnetic flux can be obtained. On the longer sides, the magnetic field passes through the voice coils perpendicularly or almost perpendicularly. On the shorter sides, the magnetic flux is guided through the iron body with just very low losses.

In one further embodiment of the electrodynamic actuator, the voice coils each can have a rectangular cross section. By use of these measures, the voice coils can provide a very good power density.

Advantageously, the voice coils can be enclosed by the first iron body on two, three or four sides of their rectangular cross sections at the shorter sides of their rectangular or oval contour and can run side by side to and spaced from the first iron body or contact the first iron body on only one side of their rectangular cross sections at the longer sides of their rectangular or oval contour. By use of these measures, again a favorable circular magnetic flux can be obtained. On the longer sides, the magnetic field passes through the voice coils perpendicularly or almost perpendicularly. On the shorter sides, the magnetic flux is guided through the iron body with just very low losses.

Advantageously, the magnet system in case a) or the movable part of the magnet system in case b) is kept free of forces in directions perpendicular to their moving direction. In turn, the arms coupling to the magnet system or to the movable part of the magnet system can be made comparably fragile what reduces their resistance in the moving direction and thus supports a high output power and efficiency of the electrodynamic actuator. To make this happen, the air gaps between within the magnet system can be made with different width.

Advantageously, the cross sections of the voice coils can be adapted to the different air gaps and can be made differently to keep up a high output power and efficiency of the electrodynamic actuator.

Advantageously, the extension of the first iron body in a direction parallel to the excursion direction is larger than the extension of the voice coils and the aforementioned permanent magnets in said direction parallel to the excursion direction. In this way, on the one hand, the voice coils can be embedded in the first iron body on the shorter sides of the voice coils and, on the other hand, the permanent magnets can be kept within the first iron body when they are excursed.

Beneficially, the first iron body (and as well the second iron body) can be made from soft iron. In this way, the magnetic flux can be guided in a useful way and magnetic resistances can be kept small.

Beneficially, an average sound pressure level of the electrodynamic transducer or output device measured in an orthogonal distance of 10 cm from the sound emanating surface is at least 50 dB in a frequency range from 100 Hz to 15 kHz. “Average sound pressure level SPLAVG” in general means the integral of the sound pressure level SPL over a particular frequency range divided by said frequency range. In the above context, in detail the ratio between the sound pressure level SPL integrated over a frequency range from f=100 Hz to f=15 kHz and the frequency range from f=100 Hz to f=15 kHz is meant. In a more mathematical language this means:

$${SPL}_{AVG} = \frac{{\int }_{f = 100}^{f = 15000} SPL \cdot df}{15 \; 000 - 100}$$

It should be noted at this point that the embodiments proposed in view of the method of manufacturing a voice coil and the advantages obtained thereof equally apply to the voice coil as such and vice versa.

### BRIEF DESCRIPTION OF THE DRAWINGS

These and other aspects, features, details, utilities, and advantages of the invention will become more fully apparent from the following detailed description, appended claims, and accompanying drawings, wherein the drawings illustrate features in accordance with exemplary embodiments of the invention, and wherein:

FIG. 1 shows an oblique bottom view of a first example of an electrodynamic actuator;

FIG. 2 shows an oblique top view of the electrodynamic actuator of FIG. 1;

FIG. 3 shows a first oblique cross sectional view of the electrodynamic actuator of FIG. 1;

FIG. 4 shows a second oblique cross sectional view of the electrodynamic actuator of FIG. 1;

FIG. 5 shows a top view of only the voice coils and the permanent magnets of the electrodynamic actuator of FIG. 1;

FIG. 6 shows a top view of the electrodynamic of FIG. 1;

FIG. 7 shows a sectional top view of the electrodynamic of FIG. 1;

FIG. 8 shows an oblique top view of a second example of an electrodynamic actuator with spaced inner voice coils;

FIG. 9 shows a top view of only the voice coils and the permanent magnets of the electrodynamic actuator of FIG. 8;

FIG. 10 shows an oblique top view of a third example of an electrodynamic actuator with spaced inner voice coils and interconnected permanent magnets;

FIG. 11 shows a top view of only the voice coils, the permanent magnets and the second iron body of the electrodynamic actuator of FIG. 10;

FIG. 12 shows a top view of an example of an electrodynamic actuator with three nested voice coils;

FIG. 13 shows a cross sectional view of an example of an electrodynamic transducer;

FIG. 14 shows a cross sectional view of an example of a speaker and

FIG. 15 shows another example of an electrodynamic transducer with a magnet system moving as a whole.

Like reference numbers refer to like or equivalent parts in the several views.

### DETAILED DESCRIPTION OF EMBODIMENTS

Various embodiments are described herein to various apparatuses. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

It must be noted that, as used in this specification and the appended claims, the singular forms “a,” “an” and “the” include plural referents unless the content clearly dictates otherwise.

The terms “first,” “second,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

All directional references (e.g., “plus,” “minus,” “upper,” “lower,” “upward,” “downward,” “left,” “right,” “leftward,” “rightward,” “front,” “rear,” “top,” “bottom,” “over,” “under,” “above,” “below,” “vertical,” “horizontal,” “clockwise,” and “counterclockwise”) are only used for identification purposes to aid the reader's understanding of the present disclosure, and do not create limitations, particularly as to the position, orientation, or use of the any aspect of the disclosure. It is to be understood that the terms so used are interchangeable under appropriate circumstances such that the embodiments of the invention described herein are, for example, capable of operation in other orientations than those illustrated or otherwise described herein.

As used herein, the phrased “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose.

Joinder references (e.g., “attached,” “coupled,” “connected,” and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims. Nevertheless, the term “connected” within the disclosure in particular can mean “direct connection” (without intermediate parts), and the term “couple” within the disclosure in particular can mean “direct or indirect connection” (with or without intermediate parts),

All numbers expressing measurements and so forth used in the specification and claims are to be understood as being modified in all instances by the term “about” or “substantially,” which particularly means a deviation of ±10% from a reference value.

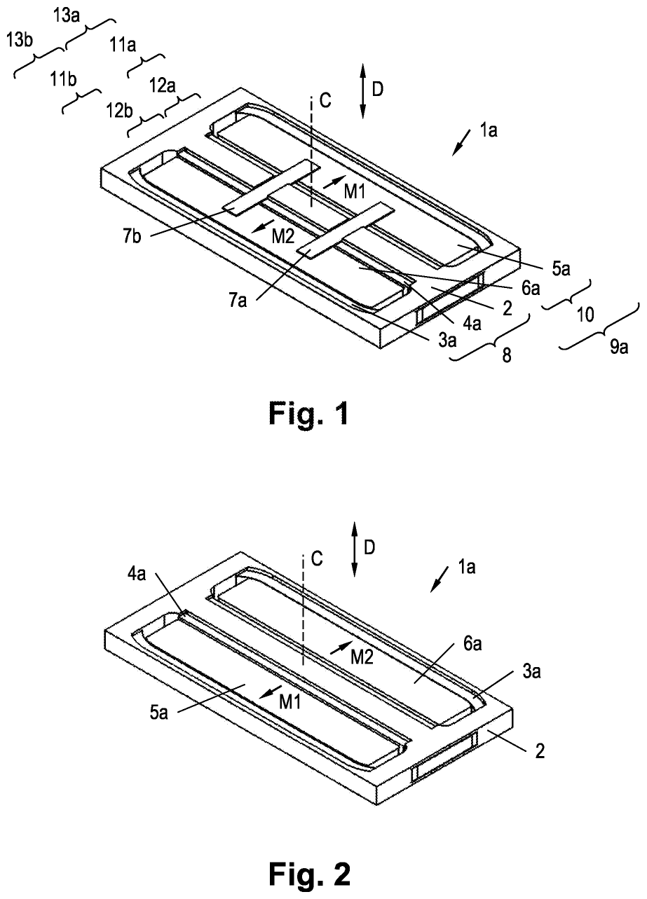

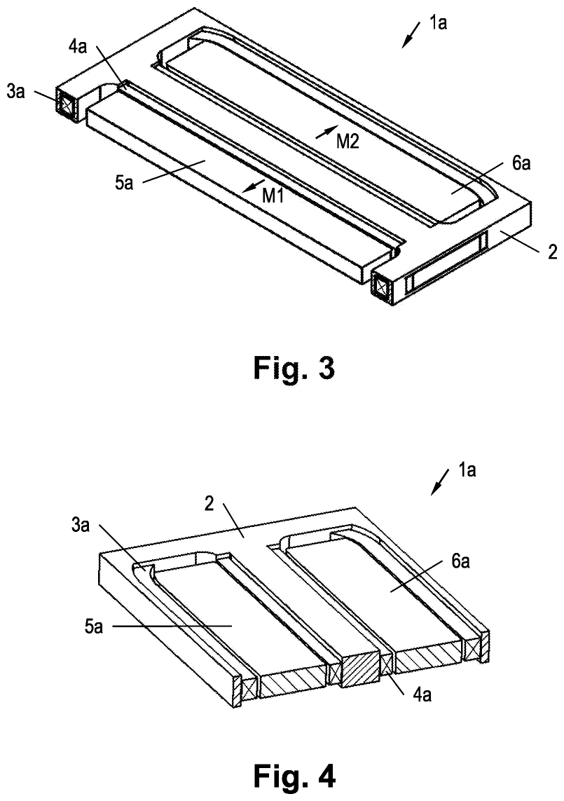

FIGS. 1 to 4 show different views of a first example of an electrodynamic actuator 1a. In detail, FIG. 1 shows an oblique bottom view of the electrodynamic actuator 1a, FIG. 2 shows an oblique top view of the electrodynamic actuator 1a, and FIGS. 3 and 4 show oblique cross sectional views of the electrodynamic actuator 1a.

The electrodynamic actuator 1a comprises a first iron body 2, which can be made from soft iron, two voice coils 3a, 4a each having an electrical conductor in the shape of loops running around a coil axis C in a loop section and a two permanent magnets 5a, 6a, each being designed to generate a magnetic field transverse to the electrical conductor in the loop section. In this example, the permanent magnets 5a, 6a are embodied as separate parts what generally allows to make the effective length of the electric conductors arranged in the magnetic field very long because there is much free space between the permanent magnets 5a, 6a.

An arrangement 8 is formed by the first iron body 2 and the two voice coils 3a, 4a, wherein the two voice coils 3a, 4a are fixed to or embedded in the first iron body 2. Furthermore, the electrodynamic actuator 1a comprises a plurality of arms 7a, 7b connecting the arrangement 8 (in particular its first iron body 2) to the permanent magnets 5a, 6a. The arms 7a, 7b allow a relative movement between said arrangement 8 and the permanent magnets 5a, 6a in an excursion direction D parallel to the coil axis C. The permanent magnets 5a, 6a in the example of FIG. 1 are each magnetized in a magnetizing direction M1, M2 transverse to the coil axis C. In this way, the electrodynamic actuator 1a can be made comparably flat in view of the strength of the magnetic field generated by the permanent magnets 5a, 6a. Accordingly, such an electrodynamic actuator 1a particularly can be used in flat consumer devices, for example in mobile phones, computer tablets, personal digital assistants, mobile computers, etc. The permanent magnets 5a, 6a are magnetized in contrary or opposite magnetizing directions M1, M2 in this example, however, other orientations are possible as well in principle.

In this example, the permanent magnets 5a, 6a and the first iron body 2 form a magnet system 9a, wherein the permanent magnets 5a, 6a form a movable part 10 of the magnet system 9a.

The magnet system 9a or the movable part 10 of the magnet system 9a respectively comprises a plurality of magnet subsystems 11a, 11b, which in the example of FIG. 1 are movable to each other in the excursion direction D. A first magnet subsystem 11a and a first part 12a of the arms 7a, 7b, which mechanically couple the voice coils 3a, 4a and the first magnet subsystem 11a, form a first oscillating system 13a with a first resonance frequency fres₁. A second magnet subsystem 11b and a second part 12b of the arms 7a, 7b, which mechanically couple the voice coils 3a, 4a and the second magnet subsystem 11b, form a second oscillating system 13b with a second resonance frequency fres₂, which is different from the first resonance frequency fres₁.

By use of these measures, distributed resonance rises in the frequency response can be obtained giving the designer of the electrodynamic transducer 1a more design freedom. In particular, a single sharp resonance can be avoided. This is particularly true if a ratio between the second resonance frequency fres₂ and the first resonance frequency fres₁ is in a range of 0.5 fres₂/fres₁≤1.0 or 1.0<fres₂/fres₁≤2.0.

It should be noted that the disclosed principle is not limited to two oscillating systems 13a, 13b, but an electrodynamic actuator 1a may also have a higher number of oscillating systems 13a, 13b and thus a higher number of resonance frequencies fres₁ and fres₂.

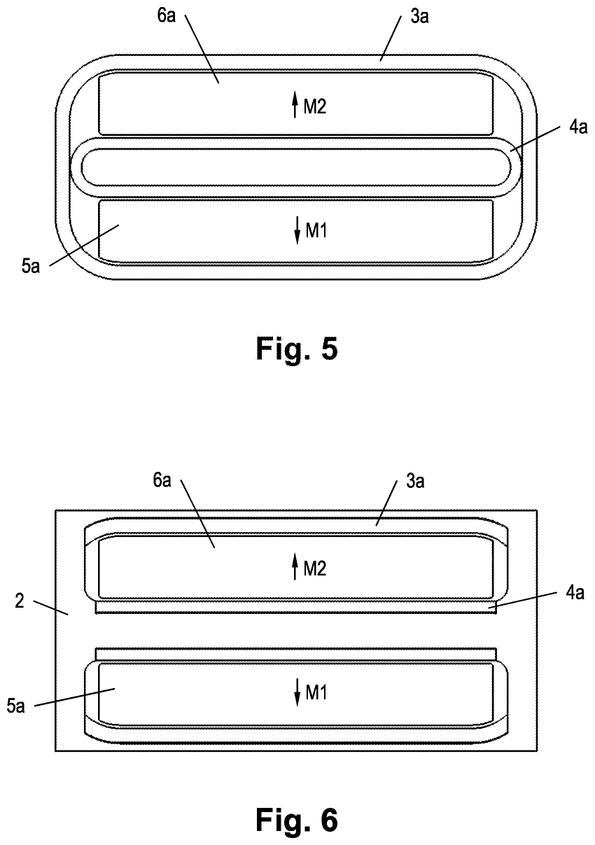

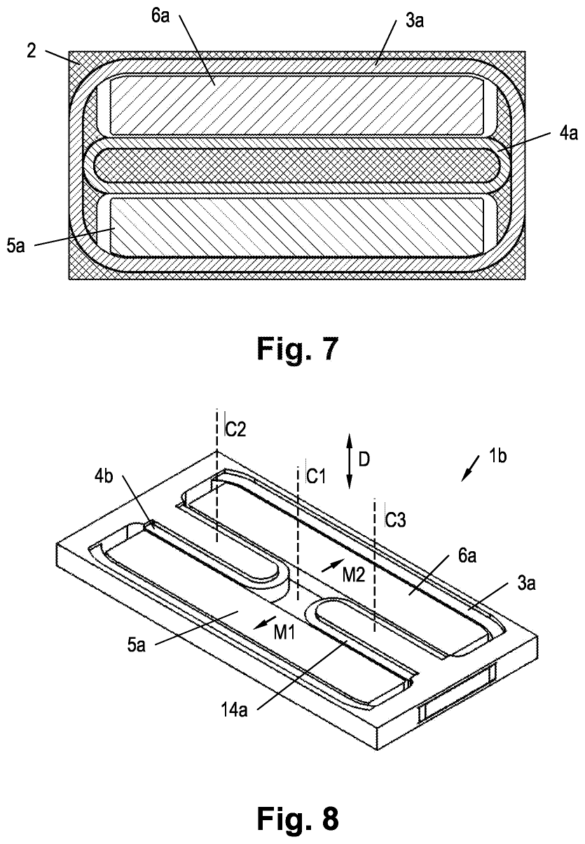

For further understanding of the electrodynamic actuator 1a, FIG. 5 now shows a top view of only the voice coils 3a, 4a and the permanent magnets 5a, 6a, FIG. 6 shows a top view of the electrodynamic actuator 1a and FIG. 7 shows a sectional top view of the electrodynamic actuator 1a.

In the example shown in FIGS. 1 to 7, the voice coils 3a, 4a are nested when viewed in a direction parallel to the excursion direction D and overlap when viewed in a direction perpendicular to the excursion direction D. In other words, the second voice coil 4a is arranged in the first voice coil 3a. In this way, the electrodynamic actuator 1a in particular can operate with permanent magnets 5a, 6a, which are magnetized in contrary magnetizing directions M1, M2 like this is shown in FIGS. 1 to 7.

By providing a plurality of voice coils 3a, 4a, generally, the effective length of the electric conductors arranged in the magnetic field generated by the permanent magnets 5a, 6a is increased in view of a solution with just one voice coil 3a. Accordingly, the force, which is implied on the arrangement 8 when currents flow through the electric conductors of the voice coils 3a, 4a is higher, too, compared to a solution with just one voice coil 3a.

As can be seen in FIGS. 1 to 7, the voice coils 3a, 4a have a rectangular or oval contour when viewed in a direction perpendicular to the excursion direction D. In this way, the voice coils 3a, 4a can be manufactured by proven technical means. Moreover, rectangular or oval voice coils 3a, 4a fit to the form factor of common mobile devices very well. However, the use of circular voice coils 3a, 4a would be possible as well.

Moreover, the voice coils 3a, 4a each have a rectangular cross section. By use of these measures, the voice coils 3a, 4a can provide a very good power density.

In more detail, the outer voice coil 3a in the example of FIGS. 1 to 7 has a rectangular contour with rounded corners, and the inner voice coil 4a has an oval contour when viewed in a direction perpendicular to the excursion direction D. In particular, the oval contour comprises parallel straight sections on the longer side. However, the inner voice coil 4a may also have a rectangular contour with rounded corners, too, as the case may be. By use of the proposed measures, the magnetic resistance of the magnetic circuit is comparably low.

In this example, the voice coils 3a, 4a—at least on a section—are fully enclosed by the first iron body 2 at the shorter sides of their rectangular or oval contour and run side by side to the first iron body 2 at the longer sides of their rectangular or oval contour. In more detail, the voice coils 3a, 4a are enclosed by the first iron body 2 on three or four sides of their rectangular cross sections at the shorter sides of their rectangular or oval contour (see FIGS. 3 and 7), whereas the voice coils 3a, 4a run side by side to and contact the first iron body 2 on only one side of their rectangular cross sections at the longer sides of their rectangular or oval contour (see FIGS. 4 and 7). By use of these measures, a favorable circular magnetic flux can be obtained. On the longer sides, the magnetic field passes through the voice coils 3a, 4a perpendicularly or almost perpendicularly. On the shorter sides, the magnetic flux is guided through the first iron body 2 with just very low losses. It should be noted that in a further embodiment of the electrodynamic actuator 1a, the voice coils 3a, 4a can be enclosed by the first iron body 2 on two sides of their rectangular cross sections at the shorter sides of their rectangular or oval contour. In yet another embodiment, the voice coils 3a, 4a can run side by side to and can be spaced from the first iron body 2 at the longer sides of their rectangular or oval contour.

Advantageously, the movable part 10 of the magnet system 9a is kept free of forces in directions perpendicular to its moving direction or perpendicular to the excursion direction D. In turn, the arms 7a, 7b connecting to the permanent magnets 5a, 6a or coupling to the movable part 10 of the magnet system 9a can be made comparably fragile what reduces their resistance in the excursion direction D and thus supports a high output power and efficiency of the electrodynamic actuator 1a. To make this happen, the air gaps between the permanent magnets 5a, 6a or within the magnet system 9a can be made with different width. Advantageously, the cross sections of the voice coils 3a, 4a can be adapted to the different air gaps and can have different cross sections to keep up a high output power and efficiency of the electrodynamic actuator 1a as this is the case in this example and as can be seen best in FIG. 4.

Advantageously, the extension of the first iron body 2 in a direction parallel to the excursion direction D is larger than the extension of the voice coils 3a, 4a and the permanent magnets 5a, 6a in said direction parallel to the excursion direction D. In this way, on the one hand, the voice coils 3a, 4a can be embedded in the first iron body 2 on the shorter sides of the voice coils 3a, 4a and, on the other hand, the permanent magnets 5a, 6a are kept within the first iron body 2 when they are excursed (see FIG. 4).

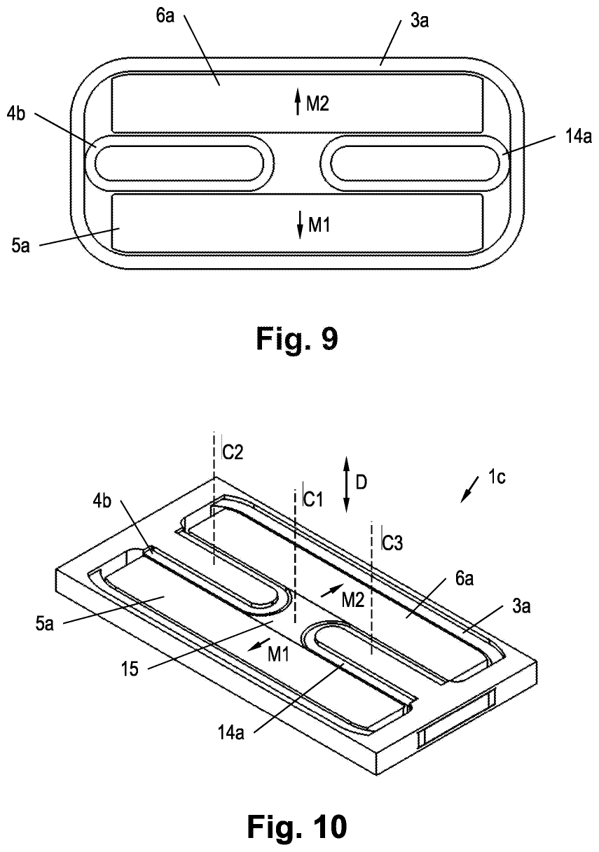

FIGS. 8 and 9 now show an alternative embodiment of an electrodynamic actuator 1b, which is very similar to the electrodynamic actuator 1a depicted in FIGS. 1 to 7. In contrast, there is a shorter second voice coil 4b but a third voice coil 14a. Here the first voice coil 3a, the second voice coil 4b and the third voice coil 14a have different coil axes C1 . . . C3. FIG. 8 shows an oblique view of the electrodynamic actuator 1b, and FIG. 9 shows a top view of only the voice coils 3a, 4b, 14a and the permanent magnets 5a, 6a of the electrodynamic actuator 1b of FIG. 8. As can be seen, the inner voice coils 4b, 14a are arranged next to each other with a space in-between.

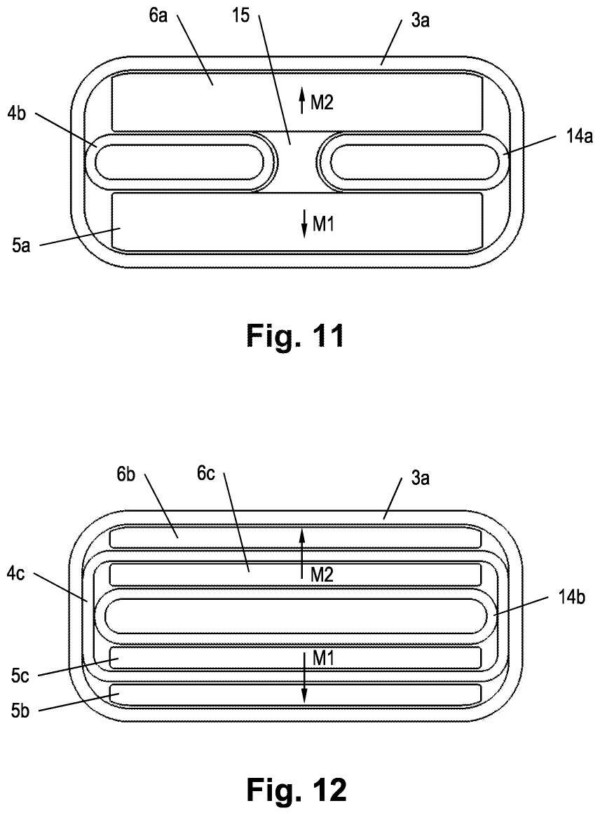

FIGS. 10 and 11 show a further embodiment of an electrodynamic actuator 1c, which is very similar to the electrodynamic actuator 1b depicted in FIGS. 8 and 9. In contrast, the electrodynamic actuator 1c comprises a second iron body 15, which connects the permanent magnets 5a, 6a and which can be made from soft iron. Generally, this possibility is provided by the space between the inner voice coils 4b and 14a. By use of the proposed measures, the permanent magnets 5a, 6a can be forced to synchronously move. Accordingly, the synchronously moving mass is increased what provides the possibility of using harder or stiffer arms 7a, 7b when the resonance frequency of the oscillating system shall be held constant. Advantageously, harder or stiffer arms 7a, 7b are more durable when it comes to mechanical stress tests, in particular to drop tests.

Alternatively, the permanent magnets 5a, 6a can also be interconnected by means of a non-iron body instead by means of the second iron body 15. When using a second iron body 15, a magnetic flux between the permanent magnets 5a, 6a may be guided, whereas the permanent magnets 5a, 6a can mechanically be interconnected without influencing the magnetic field by use of a non-iron body. Using a non-iron body, which can be made from plastics, in particular can be useful if the permanent magnets 5a, 6a are magnetized in contrary directions M1, M2 like this is the case in FIGS. 10 and 11. The non-iron body may also have distinct elasticity and damping characteristics to allow a predetermined movement between the permanent magnets 5a, 6a.

FIG. 12 shows an example for three nested voice coils 3a, 4c, 14b. In detail, the second voice coil 4c is arranged within the first voice coil 3a, and the third voice coil 14b is arranged within the second voice coil 4c. Accordingly, the permanent magnet 5a is split into two permanent magnets 5b, 5c, and the permanent magnet 6a is split into two permanent magnets 6b, 6c, wherein the permanent magnets 5b, 5c are magnetized in the magnetizing direction M1 and the permanent magnets 6b, 6c are magnetized in the magnetizing direction M2.

One should note that the principle of nested voice coils 3a, 3b, 4a . . . 4c, 14a, 14b illustrated by use of FIGS. 1 to 12 is not limited to two or three voice coils 3a, 3b, 4a . . . 4c, 14a, 14b but can also be applied to a higher number of voice coils 3a, 3b, 4a . . . 4c, 14a, 14b.

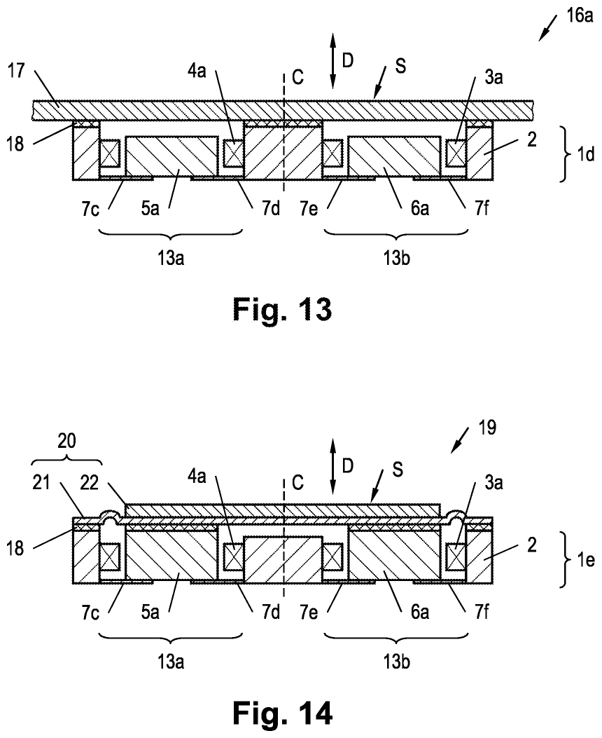

FIG. 13 now shows a cross sectional view of an example of an electrodynamic transducer 16a, which comprises a plate like structure 17 and an electrodynamic actuator 1d of the kind disclosed hereinbefore, wherein the electrodynamic actuator 1d is connected to the plate like structure 17 by means of a glue layer or adhesive sheet 18. For this reason, the electrodynamic actuator 1d advantageously comprises a flat mounting surface on the first iron body 2, which is intended to be connected to the plate like structure 17. In particular, the plate like structure 17 has a sound emanating surface S and a backside opposite to the sound emanating surface S, wherein the electrodynamic actuator 1d is connected to said backside. A connection between the plate like structure 17 and the electrodynamic actuator 1d is not necessarily done on the first iron body 2 but can also be done on the voice coils 3a, 4a or on the permanent magnets 5a, 6a. It should also be noted that a connection between the first iron body 2 and the permanent magnets 5a, 6a is done by use of separate arms 7c . . . 7f in this example, wherein the arms 7c, 7d belong to the first part 12a and to the first oscillating system 13a and wherein the arms 7e, 7f belong to the second part 12b and to the second oscillating system 13b. In this context one should note a “part of the arms” can either mean a subset of the arms 7c, 7f (like it is the case in FIG. 13) or a section or sections of the arms 7a, 7b (like it is the case in FIG. 1).

The plate like structure 17 can be a passive structure, for example a part of a housing of a device, which the electromagnetic actuator id is built into. However, the plate like structure 17 can also have a special function itself. For example, if the plate like structure 17 is embodied as a display, the electrodynamic actuator id together with the display forms an output device (for both audio and video data).

A force applied to the plate like structure 17 to generate sound may be generated by the inertia of the part of the electrodynamic actuator id which is moved in relation to the plate like structure 17 (which are the permanent magnets 5a, 6a in FIG. 13) or because the part of the electrodynamic actuator id which is moved in relation to the plate like structure 17 is fixed to another part (e.g. to a housing of a device, which the electrodynamic actuator id is built into).

FIG. 14 now shows a cross sectional view of an example of a speaker 19, which comprises an electrodynamic actuator 1e of the kind disclosed hereinbefore and a membrane 20, which is fixed to the first iron body 2 by means of a glue layer or adhesive sheet 18. Alternatively, the membrane 20 could also be connected to the voice coils 3a, 4a or to the permanent magnets 5a, 6a. The membrane 20 comprises a flexible membrane part 21 and an optional rigid membrane part 22.

The rigid membrane part 22 mainly moves in the piston mode (i.e. just up and down in excursion direction D), whereas the flexible membrane part 21 is bent. In contrast to a membrane 20, a plate like structure 17 in the sense of the example shown in FIG. 13 has no dedicated flexible part like the flexible membrane part 21. Accordingly, there is no extreme separation of deflection and piston movement like it is the case for the flexible membrane part 21 (deflection) and a rigid membrane part 22 (piston movement). Instead, sound generation is done via deflection of the whole plate like structure 17 in case of the example shown in FIG. 13.

However, it should also be noted at this point that a display forming a plate like structure 17 in FIG. 13 may be connected elastically to a housing of the device, which the display is part of. In such a case, the display may be seen as the rigid membrane part 22 of a membrane 20, wherein the display mainly moves in the piston mode, too. Accordingly, borders between an electrodynamic transducer 16a and a speaker 19 can blur into one another in such a case.

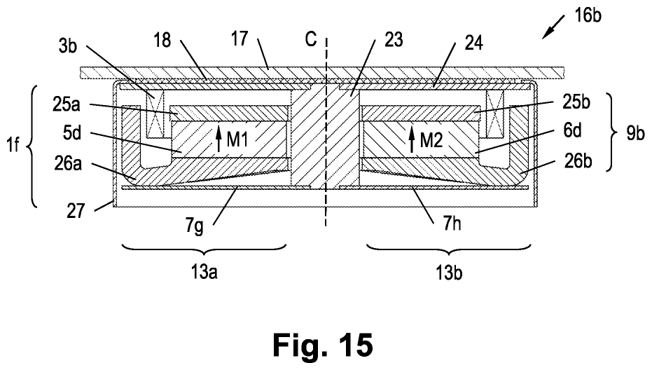

FIG. 15 now shows an embodiment of a transducer 16b with a plate like structure 17 and an electrodynamic actuator if with a different type of construction. Concretely, the electrodynamic actuator if comprises a center connector 23 with a top mounting plate 24 on its upper end and with arms 7g, 7h on its lower end. The top mounting plate 24 and hence the center connector 23 are fixed to the plate like structure 17 by use of a glue layer or adhesive sheet 18. Moreover, the electrodynamic actuator if comprises a single voice coil 3b fixed to the plate like structure 17. The arms 7g, 7h connect to the magnet system 9b, which is formed in this example by the permanent magnets 5d, 6d (which are each magnetized in a magnetizing direction M1, M2 parallel to the coil axis C in this example), the top plates 25a, 25b on the upper end of the permanent magnets 5d, 6d and the bottom plates 26a, 26b on the lower end of the permanent magnets 5d, 6d. Finally, the electrodynamic actuator 1e comprises a ring cover 27.

In the example of FIG. 15, there is no separate moving part 10 but the magnet system 9b can move relative to the voice coil 3b as a whole. The arm 7g together with the permanent magnet 5d, the top plate 25a and the bottom plate 26a forms a first oscillating system 13a with a first resonance frequency fres₁, and the arm 7h together with the permanent magnet 6d, the top plate 25b and the bottom plate 26b forms a second oscillating system 13b with a second different resonance frequency fres₂.

It should be noted that FIG. 15 just shows a representative example for an electrodynamic actuator if with permanent magnets 5d, 6d with magnetizing directions M1, M2 parallel to the coil axis C and that the principle of having different oscillating systems 13a, 13b can be applied to electrodynamic actuators with a different type of construction.

In general, a speaker 19 or an electrodynamic transducer 16a, 16b (or output device) of the kind disclosed hereinbefore preferably produces an average sound pressure level of at least 50 dB_SPL in a frequency range from 100 Hz to 15 kHz measured in an orthogonal distance of 10 cm from the sound emanating surface S. In particular, the above average sound pressure level is measured at 1 W electrical power more particularly at the nominal impedance.

It should be noted that the invention is not limited to the above mentioned embodiments and exemplary working examples. Further developments, modifications and combinations are also within the scope of the patent claims and are placed in the possession of the person skilled in the art from the above disclosure. Accordingly, the techniques and structures described and illustrated herein should be understood to be illustrative and exemplary, and not limiting upon the scope of the present invention.

The scope of the present invention is defined by the appended claims, including known equivalents and unforeseeable equivalents at the time of filing of this application. Although numerous embodiments of this invention have been described above with a certain degree of particularity, those skilled in the art could make numerous alterations to the disclosed embodiments without departing from the spirit or scope of this disclosure.

### LIST OF REFERENCES

1a . . . 1f electrodynamic actuator
2 first iron body
3a, 3b first voice coil
4a . . . 4c second voice coil
5a . . . 5d first permanent magnet
6a . . . 6d second permanent magnet
7a . . . 7h arm
8 arrangement
9a, 9b magnet system
10 movable part of magnet system
11a, 11b magnet subsystem
12a, 12b part of arms
13a, 13b oscillating system
14a, 14b third voice coil
15 second iron core
16a, 16b electrodynamic transducer
17 plate like structure/display
18 glue layer/adhesive sheet
19 speaker
20 membrane
21 flexible membrane part
22 rigid membrane part
23 center connector
24 top mounting plate
25a, 25b top plate
26a, 26b bottom plate
27 ring cover
C, C1 . . . C3 coil axis
D excursion direction
M1, M2 magnetizing direction
S sound emanating surface

What is claimed is:

1. An electrodynamic actuator (1a . . . 1f), which in particular is designed to be connected to a plate like structure (17) or membrane (20) and which comprises:
at least one voice coil (3a, 3b, 4a . . . 4c, 14a, 14b) having an electrical conductor in the shape of loops running around a coil axis (C, C1 . . . C3) in a loop section;
a magnet system (9a, 9b) being designed to generate a magnetic field transverse to the electrical conductor in the loop section; and
a plurality of arms (7a . . . 7h) mechanically coupling the at least one voice coil (3a, 3b, 4a . . . 4c, 14a, 14b),
and wherein either
a) the magnet system (9a, 9b) and allowing a relative movement between the at least one voice coil (3a, 3b, 4a . . . 4c, 14a, 14b) and said magnet system (9a, 9b) in an excursion direction (D) parallel to the coil axis (C, C1 . . . C3), or
b) a movable part (10) of the magnet system (9a, 9b) and allowing a relative movement between the at least one voice coil (3a, 3b, 4a . . . 4c, 14a, 14b) and said movable part (10) of the magnet system (9a, 9b) in an excursion direction (D) parallel to the coil axis (C, C1 . . . C3),
and wherein
in case a) the magnet system (9a, 9b) and in case b) the movable part (10) of the magnet system (9a, 9b) comprises a plurality of magnet subsystems (11a, 11b), which are movable to each other in the excursion direction (D),
and wherein
a first magnet subsystem (11a) of the magnet subsystems (11a, 11b) and a first part (12a) of the arms (7a . . . 7h), which mechanically couple the at least one voice coil (3a, 3b, 4a . . . 4c, 14a, 14b) and the first magnet subsystem (11a), form a first oscillating system (13a) with a first resonance frequency fres₁, and
a second magnet subsystem (11b) of the magnet subsystems (11a, 11b) and a second part (12b) of the arms (7a . . . 7h), which mechanically couple the at least one voice coil (3a, 3b, 4a . . . 4c, 14a, 14b) and the second magnet subsystem (11b), form a second oscillating system (13b) with a second resonance frequency fres₂, which is different from the first resonance frequency fres₁.

2. The electrodynamic actuator (1a . . . 1f) as claimed in claim 1, wherein a ratio between the second resonance frequency fres₂ and the first resonance frequency fres₁ is in a range of 0.9≤fres₂/fres₁<1.0 or 1.0<fres₂/fres₁≤1.1.

3. The electrodynamic actuator (1a . . . 1f) as claimed in claim 1, further comprising a plurality of voice coils (3a, 3b, 4a . . . 4c, 14a, 14b), each having an electrical conductor in the shape of loops running around a common coil axis (C) in loop sections or around separate coil axes (C1 . . . C3) being oriented parallel to each other,
wherein
the magnet system (9a, 9b) is designed to generate a magnetic field transverse to the electrical conductors in the loop sections, and
the arms (7a . . . 7h) allow a relative movement between the voice coils (3a, 3b, 4a . . . 4c, 14a, 14b) and in case a) the magnet system (9a, 9b) or in case b) the movable part (10) of the magnet system (9a, 9b) in an excursion direction (D) parallel to the common coil axis (C) or parallel to the separate coil axes (C1 . . . C3).

4. The electrodynamic actuator (1a . . . 1f) as claimed in claim 3, wherein the voice coils (3a, 3b, 4a . . . 4c, 14a, 14b) are nested when viewed in a direction parallel to the excursion direction (D) and at least overlap when viewed in a direction perpendicular to the excursion direction (D).

5. The electrodynamic actuator (1a . . . 1f) as claimed in claim 1, further comprising a plurality of voice coils (3a, 3b, 4a . . . 4c, 14a, 14b) that are nested when viewed in a direction parallel to the excursion direction (D),

6. The electrodynamic actuator (1a . . . 1f) as claimed in claim 5, wherein the magnet system (9a, 9b) in case b) comprises permanent magnets (5a . . . 5d, 6a . . . 6d) and a first iron body (2), wherein the movable part (10) of the magnet system (9a, 9b) is formed by or comprises the permanent magnets (5a . . . 5d, 6a . . . 6d), wherein an arrangement (8) is formed by the first iron body (2) and the at least one voice coil (3a, 3b, 4a . . . 4c, 14a, 14b), wherein the at least one voice coil (3a, 3b, 4a . . . 4c, 14a, 14b) is fixed to or embedded in the first iron body (2) and wherein the arms (7a . . . 7h) allow a relative movement between said arrangement (8) and the permanent magnets (5a . . . 5d, 6a . . . 6d) in an excursion direction (D) parallel to the coil axis (C).

7. The electrodynamic actuator (1a . . . 1f) as claimed in claim 6, wherein the permanent magnets (5a . . . 5d, 6a . . . 6d) are each magnetized in a magnetizing direction (M1, M2) transverse to the coil axis (C, C1 . . . C3).

8. The electrodynamic actuator (1a . . . 1f) as claimed in claim 5, comprising an outer voice coil (3a) of the nested voice coils (3a, 3b, 4a . . . 4c, 14a, 14b) and a plurality of inner voice coils (4b, 14) of the nested voice coils (3a, 3b, 4a . . . 4c, 14a, 14b), wherein the inner voice coils (4b, 14) are arranged next to each other with a space in-between.

9. The electrodynamic actuator (1a . . . 1f) as claimed in claim 1, comprising either:
a second iron body (15), which connects at least two parts of the magnet system (9a, 9b) in case a) or at least two parts of the movable part (10) of the magnet system (9a, 9b) in case b), or
a non-iron body, which connects at least two parts of the magnet system (9a, 9b) in case a) or at least two parts of the movable part (10) of the magnet system (9a, 9b) in case b).

10. The electrodynamic actuator (1a . . . 1f) as claimed in claim 5, wherein the voice coils (3a, 3b, 4a . . . 4c, 14a, 14b) have a circular, rectangular or oval contour when viewed in a direction perpendicular to the excursion direction (D).

11. The electrodynamic actuator (1a . . . 1f) as claimed in claim 8, wherein the outer voice coil (3a) of the nested voice coils (3a, 3b, 4a . . . 4c, 14a, 14b) has a circular contour or a rectangular contour with rounded corners and the inner voice coil (4a, 4b, 14a, 14b) of the nested voice coils (3a, 3b, 4a . . . 4c, 14a, 14b) has/have an oval contour or a rectangular contour with rounded corners when viewed in a direction perpendicular to the excursion direction (D).

12. The electrodynamic actuator (1a . . . 1f) as claimed in claim 10, wherein the voice coils (3a, 3b, 4a . . . 4c, 14a, 14b) are fully enclosed by the first iron body (2) at the shorter sides of their rectangular or oval contour and run side by side to the first iron body (2) at the longer sides of their rectangular or oval contour.

13. The electrodynamic actuator (1a . . . 1f) as claimed in claim 5, wherein the voice coils (3a, 3b, 4a . . . 4c, 14a, 14b) each have a rectangular cross section.

14. The electrodynamic actuator (1a . . . 1f) as claimed in claim 10, wherein the voice coils (3a, 3b, 4a . . . 4c, 14a, 14b) are enclosed by the first iron body (2) on two, three or four sides of their rectangular cross sections at the shorter sides of their rectangular or oval contour, and run side by side to and spaced from the first iron body (2) or contact the first iron body (2) on only one side of their rectangular cross sections at the longer sides of their rectangular or oval contour.

15. The electrodynamic actuator (1a . . . 1f) as claimed in claim 5, wherein the cross section of the voice coils (3a, 3b, 4a . . . 4c, 14a, 14b) is different.

16. The electrodynamic actuator (1a . . . 1f) as claimed in claim 6, wherein the extension of the first iron body (2) in a direction parallel to the excursion direction (D) is larger than the extension of the voice coils (3a, 3b, 4a . . . 4c, 14a, 14b) and the permanent magnets (5a . . . 5d, 6a . . . 6d) in said direction parallel to the excursion direction (D).

17. The electrodynamic actuator (1a . . . 1f) as claimed in claim 1, wherein the first iron body (2) is made from soft iron.

18. The electrodynamic actuator (1a . . . 1f) as claimed in claim 1, wherein the at least one voice coil (3a, 3b, 4a . . . 4c, 14a, 14b) or the magnet system (9a, 9b) comprises a flat mounting surface, which is intended to be connected to the plate like structure (17).

19. An electrodynamic transducer (16a, 16b), comprising a plate like structure (17) and an electrodynamic actuator (1a . . . 1f) connected to the plate like structure (17), wherein the electrodynamic actuator (1a . . . 1f) is designed according to claim 1.

20. The electrodynamic transducer (16a, 16b) as claimed in claim 19, wherein an average sound pressure level of the electrodynamic transducer (16a, 16b) measured in an orthogonal distance of 10 cm from the sound emanating surface (S) is at least 50 dB_SPL in a frequency range from 100 Hz to 15 kHz.

21. An output device comprising an electrodynamic transducer (16a, 16b) as claimed in claim 19, wherein the plate like structure (17) is embodied as a display, wherein the electrodynamic actuator (1a . . . 1f) is connected to the backside of the display.

22. A speaker (19), comprising an electrodynamic actuator (1a . . . 1f) as claimed in claim 1 and a membrane (20), which is fixed thereto.
